(19) United States
(12) Patent Application Publication
(10) Pub. No.: US 2006/0285287 A1
(43) Pub. Date: Dec. 21, 2006

(54) PROTECTING APPARATUS FOR STORAGE DEVICE

(76) Inventors: Hsuan-Chen Chen, Shenzhen (CN); Chien-Li Tsai, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,456

(22) Filed: Dec. 29, 2005

(30) Foreign Application Priority Data
Jun. 17, 2005 (CN) 200520060231.8

(51) Int. Cl. G06F 1/16

(52) U.S. Cl. 361/685

(57) ABSTRACT

A protecting apparatus for a storage device includes a bracket, a fixing member, and a fastener. The bracket includes a front wall and a bottom wall. A hole is defined in the front wall, and a plurality of slots is defined in the bottom wall. The fixing member includes a bottom panel for holding the storage device, and a front panel formed from an edge of the bottom panel. A plurality of latches is formed from the bottom panel engaging in the slots respectively. A projection is formed from the front panel. The fastener extends through the hole and engages in the projection for vibration absorption.

### DESCRIPTION

1. Field of the Invention

The present invention relates to a protecting apparatus, and more particularly to a protecting apparatus for a storage device.

2. Description of Related Art

Typically, a storage device is fixed in a portable computer by a bracket. The bracket includes two sidewalls, and each of the sidewalls defines a plurality of holes. A plurality of threaded holes is defined in two sidewalls of the storage device corresponding to the holes of the bracket. A plurality of screws is provided to extend through the holes of the bracket and engage in corresponding threaded holes of the storage device. The storage device is thus attached to the sidewalls of the bracket. However, due to direct attachment of the storage device with the bracket, the storage device will be impacted when a vibration happens, and it may lead an unwilling damage. Otherwise, because there is a plurality of screws directly engaging in the storage device, when fastening forces of different screws are asymmetric, the storage device is more apt to be damaged in case a vibration happens.

What is needed, therefore, is a protecting apparatus which is able to provide a better protection to a storage device.

### SUMMARY OF INVENTION

An exemplary protecting apparatus for a storage device includes a bracket, a fixing member, and a fastener. The bracket includes a front wall and a bottom wall. A hole is defined in the front wall, and a plurality of slots is defined in the bottom wall. The fixing member includes a bottom panel for holding the storage device, and a front panel formed from an edge of the bottom panel. A plurality of latches is formed from the bottom panel engaging in the slots respectively. A projection is formed from the front panel. The fastener extends through the hole and engages in the projection for vibration absorption.

Other advantages and novel features will become more apparent from the following detailed description of a preferred embodiment when taken in conjunction with the accompanying drawings, in which:

### BRIEF DESCRIPTION OF DRAWINGS

FIG. 1 is an exploded, isometric view of a protecting apparatus with a storage device in accordance with a preferred embodiment of the present invention;

FIG. 2 is similar to FIG. 1, showing the storage device is mounted in a fixing member, but viewed from another aspect;

FIG. 3 is an assembled view of FIG. 2, but viewed from another aspect; and

FIG. 4 is similar to FIG. 3, but viewed from another aspect.

### DETAILED DESCRIPTION

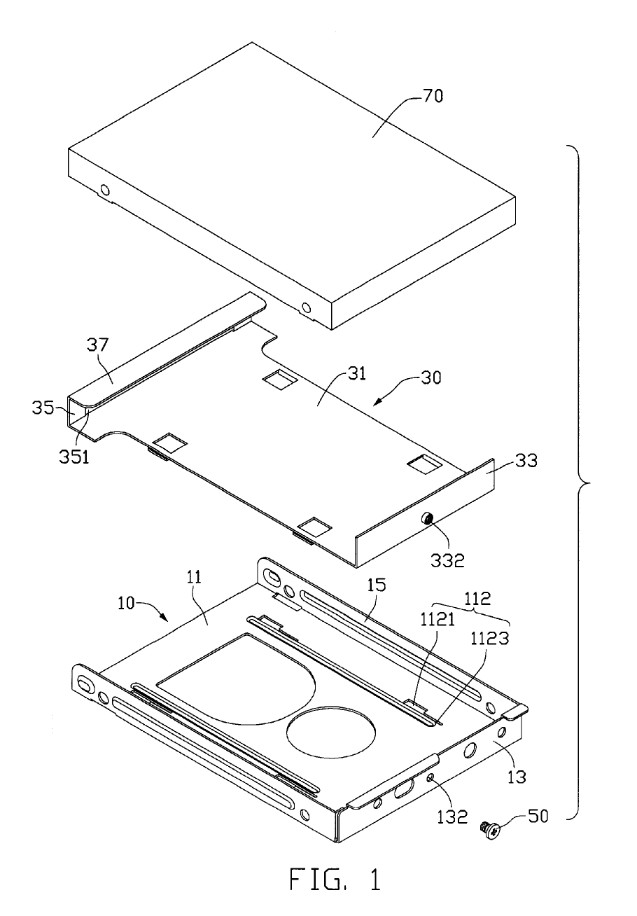

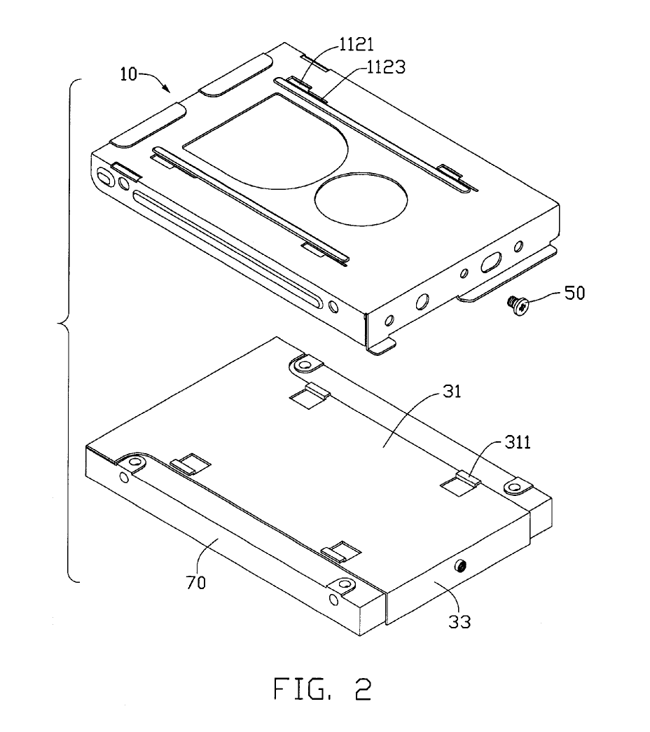

Referring to FIGS. 1 and 2, a protecting apparatus for a storage device is provided in accordance with a preferred embodiment of the present invention. The protecting apparatus includes a bracket 10, a fixing member 30 and a fastener 50.

The bracket10 includes a bottom wall 11. Four slots 112 are defined in the bottom wall 11, and each of the slots 112 includes an entrance portion 1121 and a retention portion 1123. The retention portion 1123 is in communication with the entrance portion 1121. A front wall 13 is bent perpendicularly upwardly from a front edge of the bottom wall 11. A hole 132 is defined in the front wall 13. Two opposite sidewalls 15 are formed upwardly from two sides of the bottom wall 11, with an end of each of the sidewalls 15 adjoining the front wall 13.

The fixing member 30 includes a bottom panel 31. Four generally L-shaped latches 311 are stamped from the bottom panel 31, corresponding to the slots 112 of the bracket 10. A front panel 33 is bent from a front edge of the bottom panel 31 corresponding to the front wall 13 of the bracket 10. A projection 332 with an internal threaded hole therein projects perpendicularly outwardly from the front panel 33. A rear panel 35 is bent from a rear edge of the bottom panel 31. A receiving space is defined between the front panel 33 and the rear panel 35. An opening 351 is defined in the rear panel 35. A flange 37 is bent perpendicularly from a top edge of the rear panel 35 toward the front panel 33. The fixing member 30 is made of metal or other material which provides Electro Magnetic Interference (EMI) shielding.

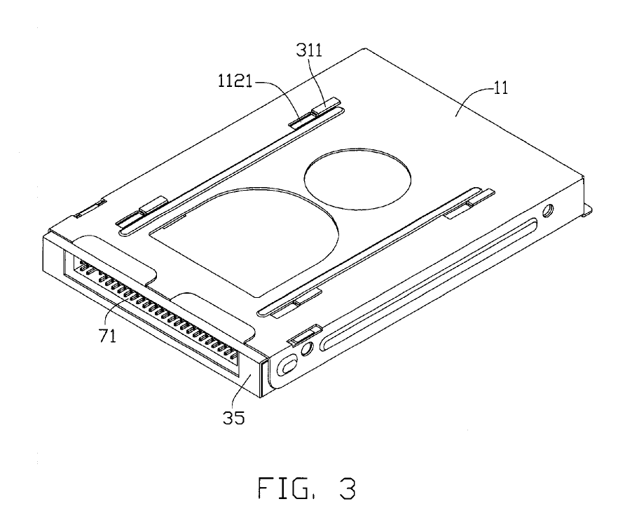

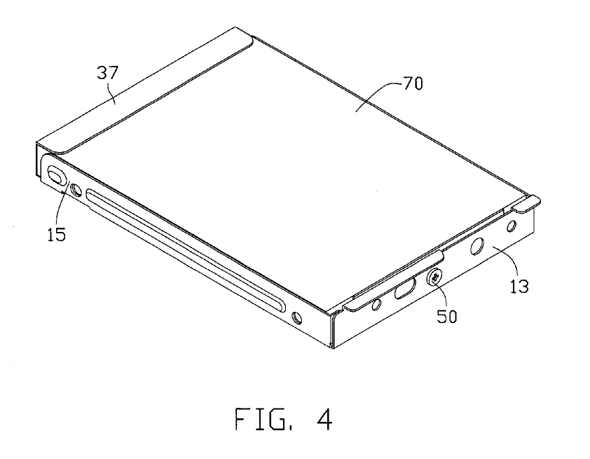

As shown in FIGS. 3 and 4, in assembly, a storage device 70 is installed into the receiving space of the fixing member 30 between the front panel 33 and the rear panel 35. The storage device 70 is placed on the bottom panel 31 of the fixing member 30, two ends of the storage device 70 respectively engaging the front panel 33 and the rear panel 35 of the fixing member 30. A connector 71 of the storage device 70 corresponds to the opening 351 of the rear panel 35. An upper surface of the storage device 70 abuts against the flange 37 of the fixing member 30. In this embodiment, the storage device 70 is a hard disk drive.

The fixing member 30 with the storage device 70 is then placed into the bracket 10, with the latches 311 of the fixing member 30 extending through the entrance portions 1121 of the bottom wall 11 of the bracket 10 respectively. Pushing the fixing member 30 toward the front wall 13 of the bracket 10, the latches 311 of the fixing member 30 enter the communicating retention portions 1123 from corresponding entrance portions 1121 respectively. When the projection 332 of the fixing member 30 engages with the front wall 13 of the bracket 10, the latches 311 of the fixing member 30 hook the bottom wall 11 of the bracket 10, and the threaded hole of the projection 332 aligns with the hole 132 of the front wall 13 of the bracket 10. The fastener 50 extends through the hole 132 and engages in the projection 332 to attach the fixing member 30 to the bracket 10. In this embodiment, the fastener 50 is a screw.

The storage device 70 is fixed in the bracket 10, via the storage device 70 received in the fixing member 30, the latches 311 of the fixing member 30 hooking the bottom wall 11 of the bracket 10, and the fastener 50 attaching the fixing member 30 to the front wall 13 of the bracket 10. When a vibration happens, external forces can be passed to the storage device 70 equably through the fixing member 30. The protecting apparatus provides a good vibration protection to the storage device 70. In addition, the fixing member 30 also has an effect of EMI shielding.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A protecting apparatus for a storage device comprising:
a bracket comprising a front wall and a bottom wall, a hole defined in the front wall, and a plurality of slots defined in the bottom wall;
a fixing member comprising a bottom panel for holding the storage device, and a front panel formed from an edge of the bottom panel, a plurality of latches formed from the bottom panel engaging in the slots respectively, a projection formed from the front panel; and
a fastener extending through the hole and engaging in the projection for vibration absorption.

2. The protecting apparatus as claimed in claim 1, wherein each of the slots comprises a retention portion, each of the latches is generally L-shaped in construction and engages in corresponding retention portion and hooks the bottom wall of the bracket.

3. The protecting apparatus as claimed in claim 2, wherein each of the slots further comprises an entrance portion communicating with the retention portion, and each of the latches extends through the entrance portion to enter the corresponding retention portion.

4. The protecting apparatus as claimed in claim 1, wherein a rear panel is formed from another edge of the bottom panel opposite to the front panel, and a receiving space for the storage device is defined between the front panel and the rear panel.

5. The protecting apparatus as claimed in claim 1, wherein the fastener is a screw.

6. The protecting apparatus as claimed in claim 1, wherein two opposite sidewalls are formed from two sides of the bottom wall of the bracket respectively, and an end of each of the sidewalls adjoins the front wall.

7. A protecting apparatus assembly comprising:
a bracket comprising a front wall and a bottom wall, a hole defined in the front wall, and a plurality of slots defined in the bottom wall;
a storage device;
a fixing member comprising a bottom panel for holding the storage device, and a front panel formed from an edge of the bottom panel, a plurality of latches formed from the bottom panel engaging in the slots respectively, a projection arranged to the front panel; and
a fastener extending through the hole and engaging in the projection for vibration absorption.

8. The protecting apparatus assembly as claimed in claim 7, wherein each of the slots comprises a retention portion, each of the latches is generally L-shaped in construction and engages in corresponding retention portion and hooks the bottom wall of the bracket.

9. The protecting apparatus assembly as claimed in claim 8, wherein each of the slots further comprises an entrance portion communicating with the retention portion thereof, and each of the latches extends through the entrance portion to enter the corresponding retention portion.

10. The protecting apparatus assembly as claimed in claim 7, wherein a rear panel is formed from another edge of the bottom panel opposite to the front panel, and the storage device is held between the front panel and the rear panel.

11. The protecting apparatus assembly as claimed in claim 10, wherein a flange is bent from a free edge of the rear panel, and engages a surface of the storage device.

12. The protecting apparatus assembly as claimed in claim 10, wherein an opening is defined in the rear panel, and a connector arranged to the storage device corresponds to the opening.

13. The protecting apparatus assembly as claimed in claim 7, wherein the fastener is a screw to engage in a threaded hole defined in the projection.

14. The protecting apparatus assembly as claimed in claim 7, wherein two opposite sidewalls are formed from two sides of the bottom wall of the bracket respectively, and an end of each of the sidewalls adjoins the front wall.
